(19) United States
(12) Patent Application Publication
(10) Pub. No.: US 2013/0270884 A1
(43) Pub. Date: Oct. 17, 2013

(54) RECLINER MECHANISM WITH DUMP FEATURE

(71) Applicant: FISHER & COMPANY, INCORPORATED, St. Clair Shores, MI (US)

(72) Inventors: Joseph C. Espinosa, Shelby Township, MI (US); Andrew Joshua Simms, Royal Oak, MI (US); John J. Berndtson, Grosse Pointe Woods, MI (US); David L. Robinson, Sterling Heights, MI (US)

(73) Assignee: FISHER & COMPANY, INCORPORATED, St. Clair Shores, MI (US)

(21) Appl. No.: 13/859,349

(22) Filed: Apr. 9, 2013

Related U.S. Application Data
(60) Provisional application No. 61/622,568, filed on Apr. 11, 2012.

(51) Int. Cl. B60N 2/20

(52) U.S. Cl. CPC B60N 2/20
USPC 297/378.12

(57) ABSTRACT

An adjustment mechanism for a seat assembly having a seat bottom and a seatback is provided and may include a mounting bracket fixed for movement with the seat bottom. A recliner mechanism may be supported by the mounting bracket and may be movable between a locked state preventing movement of the seatback relative to the seat bottom and an unlocked state permitting movement of the seatback relative to the seat bottom. A dump mechanism may be supported by the mounting bracket and may be moved between an engaged state preventing rotation of the seatback relative to the seat bottom when the recliner mechanism is in the locked state and a disengaged state permitting rotation of the seatback relative to the seat bottom when the recliner mechanism is in the locked state.

### CROSS-REFERENCE TO RELATED APPLICATIONS

This application claims the benefit of U.S. Provisional Application No. 61/622,568, filed on Apr. 11, 2012. The entire disclosure of the above application is incorporated herein by reference.

### FIELD

The present disclosure relates to an adjustment mechanism and more particularly to an adjustment mechanism for a seat assembly.

### BACKGROUND

This section provides background information related to the present disclosure which is not necessarily prior art.

Conventional seat assemblies typically include a recliner mechanism that permits angular adjustment of a seatback relative to a seat bottom when in an unlocked state. The recliner mechanism remains in the unlocked state to permit angular adjustment of the seatback relative to the seat bottom until a desired angular position of the seatback is achieved. Once the desired angular position of the seatback is achieved, the recliner mechanism is returned to a locked state to prevent additional movement of the seatback relative to the seat bottom and to maintain a desired angular position of the seatback relative to the seat bottom.

Conventional seat assemblies may also include a so-called dump mechanism that allows a seatback to be quickly moved from an upright position to a folded or dumped position. Such dump mechanisms are typically incorporated into a seat assembly to provide access to or from rear seating positions of a vehicle and/or to provide access to a storage compartment of a vehicle. For example, a sport utility vehicle incorporating three rows of seats may provide a second row of seats with both a recliner mechanism and a dump mechanism. The recliner mechanism may be used to adjust an angular position of a seatback relative to a seat bottom and may also be used to allow the seatback to be moved from an upright position to a dumped position to provide access to or from a third row of seats located behind the second row of seats.

While conventional seat assemblies may incorporate a recliner mechanism and a dump mechanism, conventional recliner mechanisms may become damaged should the recliner mechanism be driven when the seatback is in a folded or dumped position. Further, conventional dump mechanisms are often difficult to actuate if the seatback is preloaded. Namely, if a force is applied to the seatback (i.e., by an occupant pushing the seatback in a direction toward the dumped position) prior to actuation of the dump mechanism, conventional dump mechanisms are difficult to release. Under such circumstances, the force applied to the seatback must first be released before the dump mechanism can be released and the seatback rotated from the upright position to the dumped position.

### SUMMARY

This section provides a general summary of the disclosure, and is not a comprehensive disclosure of its full scope or all of its features.

An adjustment mechanism for a seat assembly having a seat bottom and a seatback is provided and may include a mounting bracket fixed for movement with the seat bottom. A recliner mechanism may be supported by the mounting bracket and may be movable between a locked state preventing movement of the seatback relative to the seat bottom and an unlocked state permitting movement of the seatback relative to the seat bottom. A dump mechanism may be supported by the mounting bracket and may be moved between an engaged state preventing rotation of the seatback relative to the seat bottom when the recliner mechanism is in the locked state and a disengaged state permitting rotation of the seatback relative to the seat bottom when the recliner mechanism is in the locked state.

An adjustment mechanism for a seat assembly is provided and may include a seat bottom and a seatback. A recliner mechanism may be movable between a locked state preventing movement of the seatback relative to the seat bottom and an unlocked state permitting movement of the seatback relative to the seat bottom. A dump mechanism may move between an engaged state preventing rotation of the seatback relative to the seat bottom when the recliner mechanism is in the locked state and a disengaged state permitting rotation of the seatback relative to the seat bottom when the recliner mechanism is in the locked state. The dump mechanism may include a locking cam supported by a mounting bracket fixed for movement with the seat bottom, whereby the locking cam translates and rotates relative to the mounting bracket to permit movement of the dump mechanism from the engaged state to the disengaged state.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of an adjustment mechanism in accordance with the principles of the present disclosure;

FIG. 2 is an exploded view of the adjustment mechanism of FIG. 1;

FIG. 3 is a side view of the adjustment mechanism of FIG. 1 with part of a housing removed to show internal components of a dump mechanism of the adjustment mechanism in an engaged state and to show internal components of a recliner mechanism of the adjustment mechanism in a locked state;

FIG. 4 is a side view of the adjustment mechanism of FIG. 1 with part of a housing removed to show internal components of a dump mechanism of the adjustment mechanism moving from an engaged state to a disengaged state;

FIG. 5 is a side view of the adjustment mechanism of FIG. 1 with part of a housing removed to show internal components of the dump mechanism of the adjustment mechanism in an disengaged state;

FIG. 6 is a partial perspective view of a seat assembly incorporating the adjustment mechanism of FIG. 1;

FIG. 7 is a partial perspective view of the seat assembly of FIG. 6 showing a seatback in a reclined position; and

FIG. 8 is a partial perspective view of the seat assembly of FIG. 6 showing a seatback in a dumped position.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

With reference to the figures, an adjustment mechanism 10 is provided and may include a recliner mechanism 12 and a dump mechanism 14. The recliner mechanism 12 and dump mechanism 14 cooperate to permit selective movement of a support bracket 16 relative to a mounting bracket 18. Specifically, the recliner mechanism 12 permits angular adjustment of the support bracket 16 relative to the mounting bracket 18 to allow the support bracket 16 to be positioned in any one of a number of angular positions relative to the mounting bracket 18. The dump mechanism 14 permits the support bracket 16 to be moved from an upright position to a dumped position. The dump mechanism 14 also allows the support bracket 16 to be returned to its previous angular position relative to the mounting bracket 18 when the support bracket 16 is moved from the dumped position back to the upright position, as the recliner mechanism 12 remains in a locked state through movement of the support bracket 16 between the upright position and the dumped position.

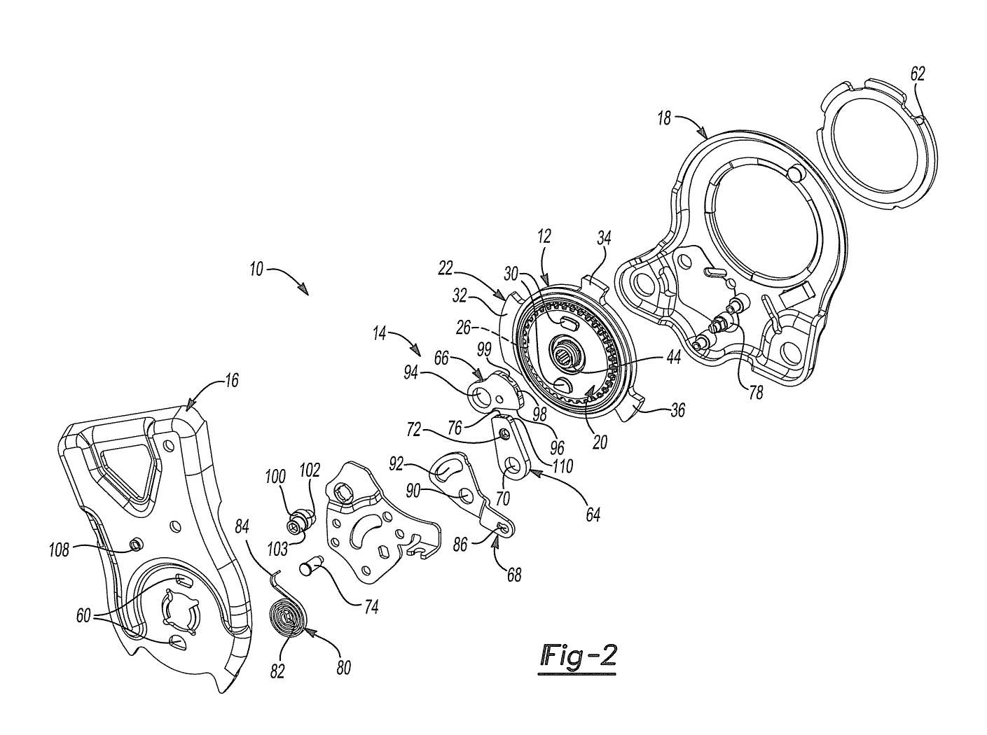

With particular reference to FIGS. 2-5, the recliner mechanism 12 is shown as being a constantly engaged, powered round-recliner mechanism. While the recliner mechanism 12 is shown as being a constantly engaged round-recliner mechanism, the recliner mechanism 12 could alternatively be a discontinuous round-recliner mechanism. Further, while the recliner mechanism 12 is described as being a powered round-recliner mechanism, the recliner mechanism 12 could alternatively be a manually actuated round-recliner mechanism.

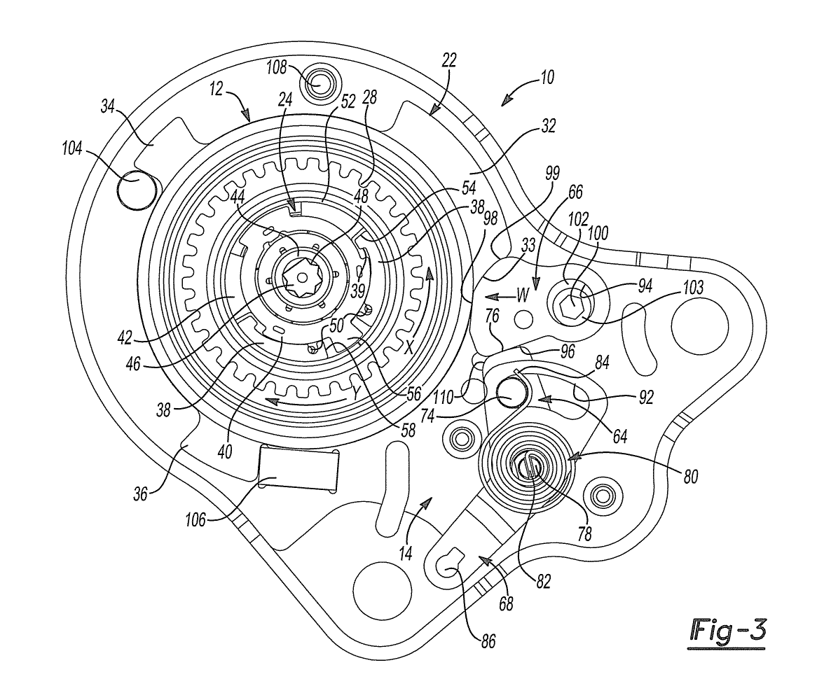

The recliner mechanism 12 may include a first gear plate 20, a second gear plate 22, and a locking mechanism 24 (FIG. 3) that is movable between a locked state preventing relative movement between the first gear plate 20 and the second gear plate 22 and an unlocked state permitting relative movement between the first gear plate 20 and the second gear plate 22. The first gear plate 20 may include a series of teeth 26 as well as a pair of attachment features 30. The second gear plate 22 may also include a series of teeth 28 that are in constant, meshed engagement with the teeth 26 of the first gear plate 20. The second gear plate 22 may additionally include a first projection 32, a second projection 34, and a third projection 36 extending from the second gear plate 22.

The locking mechanism 24 may be disposed between the first gear plate 20 and the second gear plate 22 and may include a pair of locking cams 38, an eccentric cam 40, and an actuator cam 42. The locking mechanism 24 may additionally include a center pivot 44 that is fixed for rotation with the actuator cam 42 and a cross rod 46 that selectively applies a rotational force on the center pivot 44. For example, the cross rod 46 may include an outer spline 48 that is matingly received by an inner diameter of the center pivot 44 to fix the center pivot 44 for rotation with the spline 48. The actuator cam 42 may include a similar feature (not shown) that fixes the actuator cam 42 for rotation with the center pivot 44. Therefore, when a rotational force is applied to the cross rod 46, the force is translated to the actuator cam 42 via the center pivot 44 to cause the actuator cam 42 and center pivot 44 to rotate with the cross rod 46 relative to the mounting bracket 18.

The locking cams 38 may be biased in opposite rotational directions by a biasing member 50. Specifically, one of the locking cams 38 may be biased in a first rotational direction (X) while the other locking cam 38 may be biased at an opposite, second rotational direction (Y). Biasing the locking cams 38 in the respective first and second rotational directions (X, Y) causes each locking cam 38 to wedge between the eccentric cam 40 and a collar 52 (FIG. 3) to prevent relative rotation between the first gear plate 20 and the second gear plate 22. When the locking cams 38 are in the wedged position, as shown in FIG. 3, the locking mechanism 24 is in the locked state, which prevents relative rotation between the first gear plate 20 and the second gear plate 22.

Relative rotation between the first gear plate 20 and the second gear plate 22 may be accomplished by applying a rotational force on the eccentric cam 40 via the actuator cam 42, center pivot 44, and cross rod 46. Specifically, a motor (not shown) associated with the recliner mechanism 12 may apply a rotational force on the cross rod 46 to rotate the cross rod 46 relative to the mounting bracket 18. Rotation of the cross rod 46 likewise causes rotation of the center pivot 44 and the actuator cam 42 relative to the mounting bracket 18, as the center pivot 44 and the actuator cam 42 are fixed for rotation with the cross rod 46, as described above.

The cross rod 46 may be rotated in either the clockwise direction or the counterclockwise direction relative to the view shown in FIG. 3 to adjust a position of the support bracket 16 relative to the mounting bracket 18. Operation of the locking mechanism 24 is virtually identical whether the cross rod 46 is rotated in the clockwise direction or in the counterclockwise direction relative to the view shown in FIG. 3. The only difference in operation between rotation of the cross rod 46 in the clockwise direction or rotation of the cross rod 46 in the counterclockwise direction is the resulting direction of adjustment of the support bracket 16 relative to the mounting bracket 18. Because rotation of the cross rod 46 in the clockwise direction and in the counterclockwise direction results in virtually identical operation of the locking mechanism 24, operation of the locking mechanism 24 will be described only with respect to rotation of the cross rod 46 in the clockwise direction relative to the view shown in FIG. 3.

When the motor associated with the recliner mechanism 12 is energized, the cross rod 46 may be driven in the clockwise direction relative to the view shown in FIG. 3. Upon sufficient rotation of the cross rod 46 in the clockwise direction relative to the view shown in FIG. 3, the actuator cam 42—via the center pivot 44—engages one of the locking cams 38 at an end 54, thereby causing the locking cam 38 to move against the force applied on the locking cam 38 by the biasing member 50 and causes the locking cam 38 to likewise rotate in the clockwise direction relative to the view shown in FIG. 3 (i.e., in direction (Y)).

Continued rotation of the locking cam 38 in the clockwise direction relative to the view shown in FIG. 3 causes the locking cam 38 to contact the eccentric cam 40 at a projection 39 of the locking cam 38 to rotate the eccentric cam 40 in the clockwise direction relative to the view shown in FIG. 3. Such movement of the eccentric cam 40 results in a projection 56 of the eccentric cam 40 contacting an end 58 of the other locking cam 38. When the projection 56 of the eccentric cam 40 contacts the end 58 of the other locking cam 38, each locking cam 38 is essentially uncoupled from an area between the eccentric cam 40 and the collar 52, which allows relative movement between the first gear plate 20 and the second gear plate 22. Movement between the first gear plate 20 and the second gear plate 22 is accomplished by the eccentric cam 40 causing the first gear plate 20 to rotate about the second gear plate 22 while maintaining constant engagement between the teeth 26 of the first gear plate 20 and the teeth 28 of the second gear plate 22.

Once the first gear plate 20 and the second gear plate 22 are permitted to rotate relative to one another, the support bracket 16 is likewise permitted to rotate relative to the mounting bracket 18 to adjust a rotational position of the support bracket 16 relative to the mounting bracket 18. In this position, the locking mechanism 24 is in an unlocked state and will only return to the locked state once the rotational force applied to the cross rod 46 is removed and the biasing member 50 is permitted to once again wedge the locking cams 38 between the eccentric cam 40 and the collar 52.

In one configuration, the first gear plate 20 is fixed for movement with the support bracket 16. Specifically, the attachment features 30 of the first gear plate 20 may be respectively received within attachment apertures 60 of the support bracket 16 to fix the first gear plate 20 for movement with the support bracket 16. Therefore, when the locking mechanism 24 is in the unlocked state and the first gear plate 20 is permitted to rotate relative to the second gear plate 22, the support bracket 16 is likewise permitted to rotate relative to the mounting bracket 18. Conversely, when the locking mechanism 24 is in a locked state such that the first gear plate 20 and the second gear plate 22 are not permitted to rotate relative to one another, the support bracket 16 is likewise not permitted to rotate relative to the mounting bracket 18.

While the support bracket 16 is not permitted to rotate relative to the mounting bracket 18 when the locking mechanism 24 is in the locked state, the entire recliner mechanism 12 may be rotated relative to the mounting bracket 18 when the dump mechanism 14 is in a disengaged state. When the recliner mechanism 12 is in the locked state and is rotated relative to the mounting bracket 18, the support bracket 16 is likewise rotated with the recliner mechanism 12 relative to the mounting bracket 18 due to engagement between the attachment features 30 and the apertures 60 of the first gear plate 20.

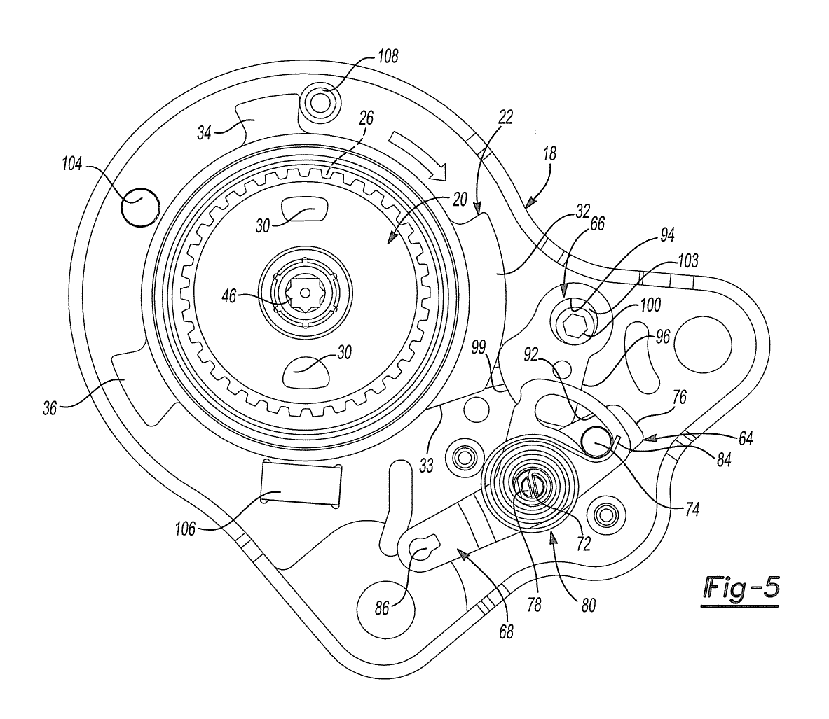

Rotation of the recliner mechanism 12 relative to the mounting bracket 18 is accomplished by moving the dump mechanism 14 from an engaged state (FIG. 3) to a disengaged state (FIG. 5) and, further, by mounting the second gear plate 22 to the mounting bracket 18 via a bushing 62 that allows the second gear plate 22 and, thus, the first gear plate 20, to rotate relative to the mounting bracket 18. In other words, the second gear plate 22 may be rotatably mounted to the mounting bracket 18 via the bushing 62 to permit rotation of the second gear plate 22 relative to the mounting bracket 18 when the dump mechanism 14 is in the disengaged state.

The dump mechanism 14 may include a locking cam 64, an actuator cam 66, and a release lever 68. The locking cam 64, actuator cam 66, and release lever 68 may be rotatably supported by the mounting bracket 18 and may cooperate to position the dump mechanism 14 in either the engaged state or the disengaged state. As described above, when the dump mechanism 14 is in the engaged state, rotation of the second gear plate 22 relative to the mounting bracket 18 is prohibited. Conversely, when the dump mechanism 14 is in the disengaged state, rotation of the second gear plate 22 relative to the mounting bracket 18 is permitted. When the second gear plate 22 is permitted to rotate relative to the mounting bracket 18, the first gear plate 20 is likewise permitted to rotate relative to the mounting bracket 18 along with the second gear plate 22, as the first gear plate 20 is fixed for movement with the second gear plate 22 when the locking mechanism 24 of the recliner mechanism 12 is in the locked state.

The first gear plate 20 may additionally be rotated relative to the mounting bracket 18 when the second gear plate 22 is prohibited from rotating relative to the mounting bracket 18 by the dump mechanism 14 only when the locking mechanism 24 of the recliner mechanism 12 is in the unlocked state. When the locking mechanism 24 is in the locked state and the dump mechanism 14 is in the engaged state, both the first gear plate 20 and the second gear plate 22 are prohibited from rotating relative to the mounting bracket 18. In sum, the first gear plate 20 may be rotated relative to the mounting bracket 18 when the locking mechanism 24 is in the unlocked state or when the dump mechanism 14 is in the disengaged state. The second gear plate 22 is only permitted to rotate relative to the mounting bracket 18 when the dump mechanism 14 is in the disengaged state, as the second gear plate 22 does not rotate relative to the mounting bracket 18 when the dump mechanism 14 is in the engaged state and the locking mechanism 24 is in the disengaged state.

The locking cam 64 may include a mounting aperture 70, a post aperture 72, and a spring post 74 mounted to the locking cam 64 within the post aperture 72. The locking cam 64 may additionally include an engagement surface 76 for selective engagement with the actuator cam 66.

The locking cam 64 may be rotatably supported by the mounting bracket 18 via a pivot 78 and may be biased in the counterclockwise direction relative to the view shown in FIG. 3 by a biasing element 80. Specifically, a first end 82 of the biasing element 80 may be fixed for rotation with the pivot 78 while a second end 84 of the biasing element 80 engages the spring post 74 to bias the locking cam 64 in the counterclockwise direction relative to the view shown in FIG. 3.

The locking cam 64 may be supported by the pivot 78 relative to the mounting bracket 18 such that the locking cam 64 is permitted to rotate about the pivot 78 and is permitted to translate relative to the pivot 78. For example, the mounting aperture 70 may include a larger diameter than an outer diameter of the pivot 78 to permit the locking cam 64 to rotate about the pivot 78 and to allow the locking cam 64 to translate relative to the pivot 78.

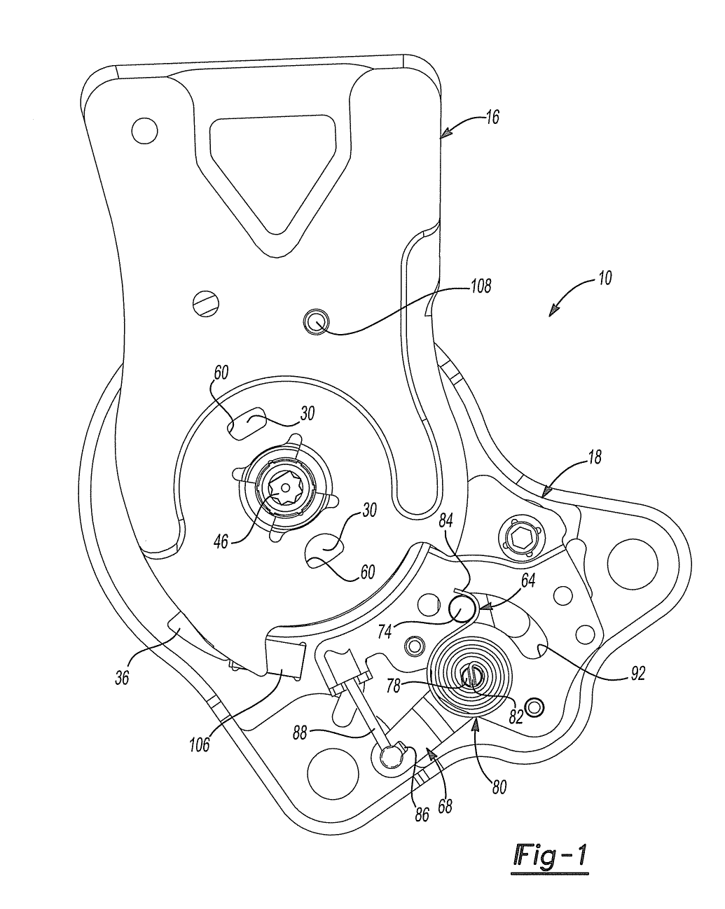

The release lever 68 may likewise be rotationally supported by the pivot 78 relative to the mounting bracket 18 and may be positioned generally between the locking cam 64 and the biasing element 80. The release lever 68 may include a cable seat 86 that receives a cable 88 (FIG. 1) and may include an attachment aperture 90 that permits the release lever 68 to be rotationally attached to the mounting bracket 18 via the pivot 78. The release lever 68 may additionally include a peanut-shaped slot 92 that slidably receives the spring post 74 therein.

The actuator cam 66 may include an attachment aperture 94, a first engagement surface 96, and a second engagement surface 98. The attachment aperture 94 may receive an eccentric pivot 100 to rotationally attach the actuator cam 66 to the mounting bracket 18 and to properly position the actuator cam 66 relative to the recliner mechanism 12 and locking cam 64 during manufacturing.

The eccentric pivot 100 may be used during manufacturing of the adjustment mechanism 10 to account for tolerances amongst the various components of the recliner mechanism 12 and dump mechanism 14. Accounting for the tolerances amongst the various components of the recliner mechanism 12 and dump mechanism 14 during assembly of the adjustment mechanism 10 allows the various components of the recliner mechanism 12 and dump mechanism 14 to be in contact with one another when the dump mechanism 14 is in the engaged state to prevent rattling or chucking during use.

During assembly of the adjustment mechanism 10, for example, the recliner mechanism 12 may be positioned such that the locking mechanism 24 is in the locked state and the dump mechanism 14 is in the engaged state (FIG. 3). The position of the actuator cam 66 relative to the mounting bracket 18 may then be adjusted by rotating the eccentric pivot 100 relative to the mounting bracket 18 until the actuator cam 66 is sufficiently moved in the direction (W) shown in FIG. 3 such that the first engagement surface 96 is in contact with the engagement surface 76 of the locking cam 64 and the second engagement surface 98 is in contact with the first projection 32 of the second gear plate 22.

Rotation of the eccentric pivot 100 relative to the mounting bracket 18 accomplishes movement of the actuator cam 66 in the direction (W) due to a lobe 102 of the eccentric pivot 100 being offset from a rotational axis of a post 103 of the eccentric pivot 100. Specifically, a central rotational axis of the lobe 102 is offset from a central rotational axis of the post 103 such that when the eccentric pivot 100 is rotated about the post 103, the lobe 102 applies a force on the actuator cam 66 to move the actuator cam 66 in the direction (W). While the eccentric pivot 100 is described as moving the actuator cam 66 in the direction (W), the eccentric pivot 100 could alternatively be rotated in the opposite direction to move the actuator cam 66 in a direction opposite to direction (W) to ensure proper contact between the actuator cam 66 and each of the locking cam 64 and first projection 32.

Once the actuator cam 66 is positioned such that the first engagement surface 96 is in contact with the engagement surface 76 of the locking cam 64 and the second engagement surface 98 is in contact with the first projection 32, the eccentric pivot 100 may be staked or otherwise attached to the mounting bracket 18 to fix a position of the eccentric pivot 100 relative to the mounting bracket 18. Fixing a position of the eccentric pivot 100 relative to the mounting bracket 18 likewise fixes the axis about which the actuator cam 66 rotates relative to the mounting bracket 18, as the actuator cam 66 rotates about the lobe 102 of the eccentric pivot 100 during use.

With particular reference to FIGS. 3-5, operation of the adjustment mechanism 10 will be described in detail. As shown in FIG. 3, the first gear plate 20 is removed to show internal components of the locking mechanism 24 in the locked state. In this position, the locking cams 38 are wedged between the eccentric cam 40 and the collar 52 and, therefore, prevent relative rotation between the first gear plate 20 and the second gear plate 22. When the first gear plate 20 is prevented from rotating relative to the second gear plate 22, the support bracket 16 is likewise prevented from rotating relative to the mounting bracket 18, as the support bracket 16 is fixed for movement with the first gear plate 20 due to engagement between the attachment features 30 of the first gear plate 20 and the apertures 60 of the support bracket 16.

The second gear plate 22 is likewise prevented from rotating relative to the mounting bracket 18 when the dump mechanism 14 is in the engaged state, as shown in FIG. 3. Namely, the biasing element 80 applies a rotational force on the locking cam 64 via interaction between the second end 84 of the biasing element 80 and the spring post 74 of the locking cam 64 to urge the locking cam 64 into engagement with the actuation cam 66, which, in turn, prevents rotation of the second gear plate 22 relative to the mounting bracket 18. Specifically, the force applied on the locking cam 64 by the biasing element 80 causes the locking cam 64 to be biased in the counterclockwise direction relative to the view shown in FIG. 3 and likewise causes the engagement surface 76 of the locking cam 64 to contact the first engagement surface 96 of the actuator cam 66. When the actuator cam 66 is in the position shown in FIG. 3, the second engagement surface 98 is engaged with the projection 32 and, therefore, prevents rotation of the second gear plate 22 relative to the mounting bracket 18.

If a force is applied to the second gear plate 22 when the dump mechanism 14 is in the engaged state (FIG. 3), the applied force is transmitted to the mounting bracket 18 via the first projection 32, the actuator cam 66, the locking cam 64, and the pivot 78. As shown in FIG. 3, such a force would be applied substantially along a longitudinal axis of the locking cam 64 and would be transmitted to the mounting bracket 18 via the locking cam 64 and pivot 78 to prevent rotation of the second gear plate 22 relative to the mounting bracket 18 in the clockwise direction relative to the view shown in FIG. 3.

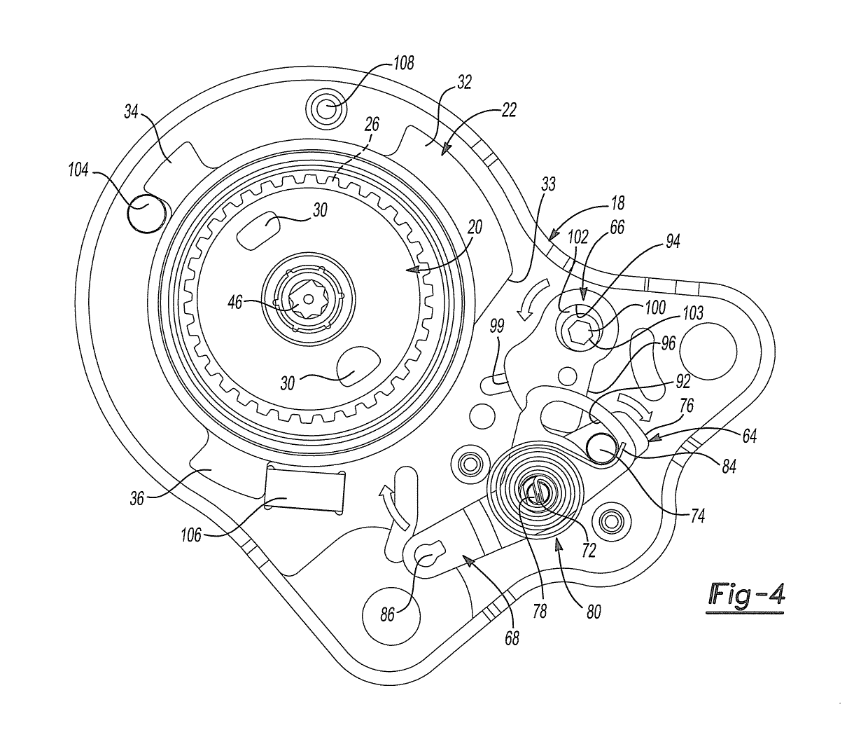

The second gear plate 22 is likewise prevented from rotating in the counterclockwise direction relative to the view shown in FIG. 3 due to engagement between the second projection 34 and a stop 104 and due to engagement between the third projection 36 and a stop 106. Engagement between the second projection 34 and stop 104 and between the third projection 36 and stop 106 prohibits rotation of the second gear plate 22 in the counterclockwise direction relative to the view shown in FIG. 4 and, therefore, likewise prevents rotation of the first gear plate 20 in the counterclockwise direction relative to the view shown in FIG. 4 when the locking mechanism 24 is in the locked state.

Angular adjustment of the support bracket 16 relative to the mounting bracket 18 may be accomplished by applying a rotational force on the cross rod 46 of the recliner mechanism 12 to move the locking mechanism 24 from the locked state to the unlocked state. As described above, the force applied to the cross rod 46 can be in either the clockwise direction or the counterclockwise direction relative to the view shown in FIG. 3 depending on the desired direction of travel of the support bracket 16 relative to the mounting bracket 18. For example, a clockwise rotational force may be applied to the cross rod 46 to cause the support bracket 16 to move in the clockwise direction relative to the view shown in FIG. 3, thereby decreasing an angle between the support bracket 16 and the mounting bracket 18. The applied rotational force causes the locking mechanism 24 to move from the locked state to the unlocked state, which allows the teeth 26 of the first gear plate 20 to move along the teeth 28 of the second gear plate 22. Moving the teeth 26 of the first gear plate 20 along the teeth 28 of the second gear plate 22 adjusts a position of the first gear plate 20 relative to the second gear plate 22, which likewise adjusts the position of the support bracket 16 relative to the mounting bracket 18.

Once a desired position of the support bracket 16 relative to the mounting bracket 18 is achieved, the force applied to the cross rod 46 may be released, thereby causing the locking mechanism 24 to move from the unlocked state to the locked state. Returning the locking mechanism 24 to the locked state fixes the position of the first gear plate 20 relative to the second gear plate 22 and, as a result, fixes the position of the support bracket 16 relative to the mounting bracket 18.

The degree of adjustment of the first gear plate 20 relative to the second gear plate 22 and, thus, the degree of adjustment of the support bracket 16 relative to the mounting bracket 18 may be defined generally between the first projection 32 and the second projection 34 of the second gear plate 22. Specifically, the support bracket 16 may include a post 108 that extends into an area between the first projection 32 and the second projection 34 of the second gear plate 22 such that the post 108 defines a range of motion of the first gear plate 20 relative to the second gear plate 22. While the support bracket 16 is now shown in FIGS. 3-5, the post 108 is illustrated to show the relative position of the post 108 and the first and second projections 32, 34 of the second gear plate 22.

The first gear plate 20 and support bracket 16 may be positioned in a forward-most adjusted position when the first gear plate 20 and support bracket 16 are rotated in the clockwise direction relative to the view shown in FIG. 3 and the post 108 contacts the second projection 34 of the second gear plate 22. Likewise, the first gear plate 20 and support bracket 16 may be positioned in a rearward-most adjusted position when the first gear plate 20 and support bracket 16 are rotated in the counterclockwise direction relative to the view shown in FIG. 3 and the post 108 contacts the first projection 32 of the second gear plate 22. In sum, an angular position of the support bracket 16 relative to the mounting bracket 18 is limited by the distance between the first projection 32 and the second projection 34 of the second gear plate 22 when the dump mechanism 14 is in the engaged state.

The recliner mechanism 12 may be rotated relative to the mounting bracket 18 when the locking mechanism 24 of the recliner mechanism 12 is in the locked state when the dump mechanism 14 is moved from the engaged state (FIG. 3) to the disengaged state (FIG. 5). Namely, a force may be applied to the release lever 68 at the cable seat 86 via the cable 88 to cause the release lever 68 to rotate in the clockwise direction relative to the view shown in FIG. 3. Rotation of the release lever 68 in the clockwise direction relative to the view shown in FIG. 3 causes the release lever 68 to contact the spring post 74 within the peanut-shaped slot 92, thereby causing the spring post 74 and locking cam 64 to likewise rotate in the clockwise direction relative to the view shown in FIG. 3 along with the release lever 68.

Upon sufficient rotation of the release lever 68 and locking cam 64 in the clockwise direction relative to the view shown in FIG. 3, the engagement surface 76 of the locking cam 64 disengages the first engagement surface 96 of the actuator cam 66, thereby allowing the actuator cam 66 to rotate about the eccentric pivot 100 in the counterclockwise direction relative to the view shown in FIG. 3. The locking cam 64 quickly rotates in the clockwise direction relative to the view shown in FIG. 3 upon rotation of the release lever 68 in the clockwise direction due to the oversized mounting aperture 70 of the locking cam 64. For example, because the mounting aperture 70 of the locking cam 64 is larger than the outer diameter of the pivot 78, the locking cam 64 quickly rotates and translates relative to the pivot 78 when initially disengaged from the actuator cam 66 to permit the actuator cam 66 to quickly and easily rotate in the counterclockwise direction relative to the view shown in FIG. 3.

Rotation and translation of the locking cam 64 is accomplished due to the forces exerted on the locking cam 64 by the release lever 68 and the actuator cam 66. The release lever 68 applies a force on the locking cam 64 via interaction between the spring post 74 and the slot 92 of the release lever 68, as previously discussed. The actuator cam 66 applies a force on the locking cam 64 when the actuator cam 66 is rotated in the counterclockwise direction under force of the first projection 32 of the second gear plate 22. In other words, the first projection 32 of the second gear plate 22 applies a force on the locking cam 64 via the actuator cam 66 disposed therebetween. Sufficient rotation of the actuator cam 66 in the counterclockwise direction relative to the view shown in FIG. 3 causes the second engagement surface 98 of the actuator cam 66 to disengage the first projection 32 of the second gear plate 22, thereby allowing the second gear plate 22 to freely rotate in the clockwise direction relative to the view shown in FIG. 3.

The efforts required to move the dump mechanism 14 from the engaged state (FIG. 3) to the disengaged state (FIG. 5) may be reduced by providing the second engagement surface 98 of the actuator cam 66 with an angled surface 99 that provides clearance between the actuator cam 66 and the first projection 32 when the engagement surface 98 initially disengages the first projection 32. The angled surface 99 provides sufficient clearance between the actuator cam 66 and the first projection 32 to allow the actuator cam 66 to quickly and easily rotate in the counterclockwise direction relative to the view shown in FIG. 3.

The first projection 32 may also include an angled surface 33 that cooperates with the angled surface 99 of the actuator cam 66 to further facilitate rotation of the actuator cam 66 in the counterclockwise direction relative to the view shown in FIG. 3 when the locking cam 64 is rotated in the clockwise direction relative to the view shown in FIG. 3. For example, the angled surface 33 of the first projection 32 is able to apply a force on the actuator cam 66 at the angled surface 99 to rotate the actuator cam 66 in the counterclockwise direction relative to the view shown in FIG. 3, once the locking cam 64 disengages the actuator cam 66. The surfaces 33, 99 effectively reduce the locking angle between the first projection 32 and the second engagement surface 98 of the actuator cam 66, which allows the first projection 32 to apply a force on and easily rotate the actuator cam 66 in the counterclockwise direction relative to the view shown in FIG. 3 to permit the second gear plate 22 to freely rotate in the clockwise direction relative to the view shown in FIG. 3.

The efforts required to move the dump mechanism 14 from the engaged state to the disengaged state may further be reduced by providing the locking cam 64 with radiused edges 110 that quickly disengage the actuator cam 66 when the locking cam 64 initially moves in the clockwise direction relative to the view shown in FIG. 3.

When the second gear plate 22 is permitted to freely rotate in the clockwise direction relative to the view shown in FIG. 3, the recliner mechanism 12 and, thus, the support bracket 16, are permitted to freely rotate in the counterclockwise direction relative to the view shown in FIG. 3 along with the second gear plate 22. The first gear plate 20 and support bracket 16 are permitted to rotate with the second gear plate 22 in the clockwise direction relative to the view shown in FIG. 3 when the dump mechanism 14 is in the disengaged state due to the locking mechanism 24 of the recliner mechanism 12 being in the locked state.

Maintaining the recliner mechanism 12 in the locked state throughout movement of the first gear plate 20, second gear plate 22, and support bracket 16 in the clockwise direction relative to the view shown in FIG. 3 relative to the mounting bracket 18 causes the entire recliner mechanism 12—including the first gear plate 20, second gear plate 22, and locking mechanism 24—to rotate with the support bracket 16 relative to the mounting bracket 18. As such, the angular position of the first gear plate 20 relative to the second gear plate 22 is maintained throughout movement of the first gear plate 20, second gear plate 22, and support bracket 16 into the dumped state.

The dump mechanism 14 may be returned to the engaged state when a force is applied to the second gear plate 22 to rotate the second gear plate 22 in the counterclockwise direction relative to the view shown in FIG. 5. Once the second gear plate 22 is sufficiently rotated in the counterclockwise direction relative to the view shown in FIG. 5, the biasing element 80 is permitted to apply a force on the locking cam 64 to rotate the locking cam 64 in the counterclockwise direction relative to the view shown in FIG. 5, which causes the radiused edged 110 of the locking cam 64 to engage the actuator cam 66. Engagement between the locking cam 64 and the actuator cam 66 causes the actuator cam 66 to rotate in the clockwise direction relative to the view shown in FIG. 5 and position the actuator cam 66 between the first projection 32 of the second gear plate 22 and the engagement surface 76 of the locking cam 64. Once the locking cam 64 and actuator cam 66 are returned to the positions shown in FIG. 3, the dump mechanism 14 is returned to the engaged state and the second gear plate 22 is once again prevented from rotating in the clockwise direction relative to the view shown in FIG. 3 relative to the mounting bracket 18.

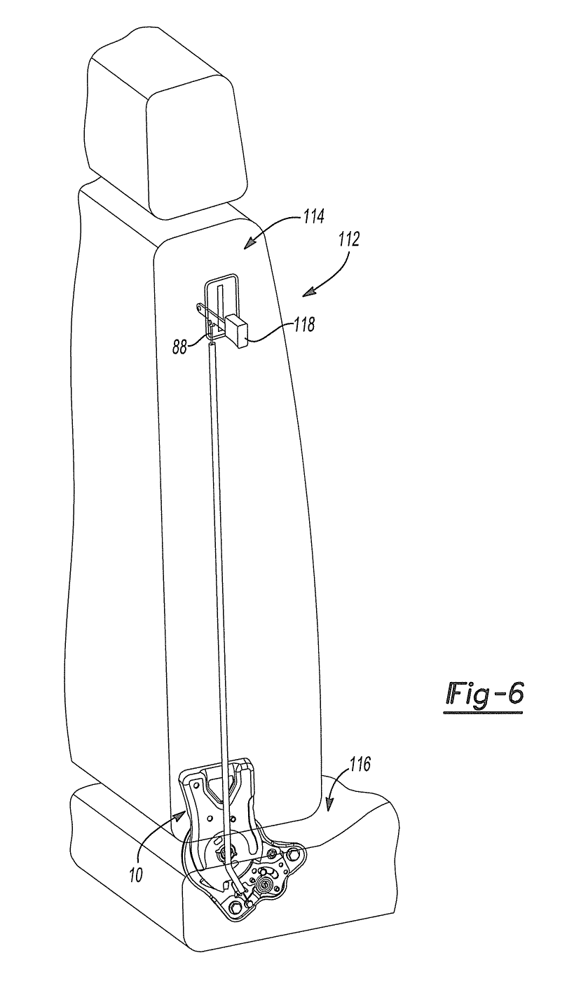

With particular reference to FIGS. 6-8, the adjustment mechanism 10 is shown incorporated into a seat assembly 112. The seat assembly 112 may include a seatback 114 rotatably mounted to a seat bottom 116. The seatback 114 may be fixed for movement with the support bracket 16 to allow a position of the seatback 114 relative to the seat bottom 116 to be adjusted when the recliner mechanism 12 is in the unlocked state or the dump mechanism 14 is in the disengaged state. The mounting bracket 18 may be fixed for movement with the seat bottom 116 to prevent movement of the mounting bracket 18 relative to the seatback 114 or the seat bottom 116.

The seat assembly 112 may include a release lever 118 in communication with the cable 88 to allow a force applied to the release lever 118 to be transmitted to the release lever 68 via the cable 88.

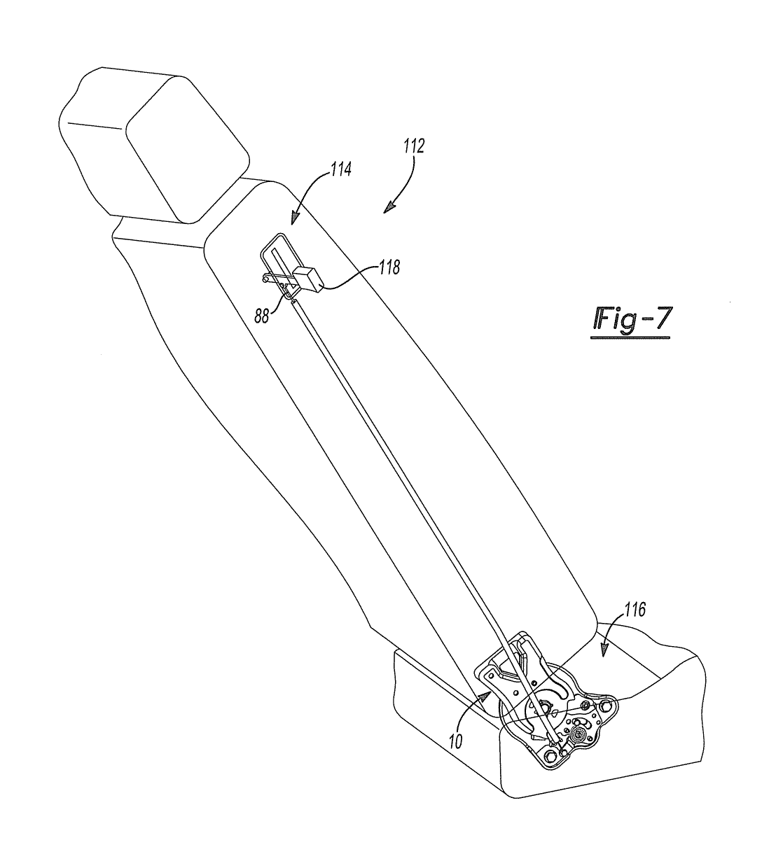

As shown in FIG. 6, the seat assembly 112 is in an upright and usable position. The seatback 114 may be reclined relative to the seat bottom 116 (FIG. 7) by applying a force on the cross rod 46, thereby causing the locking mechanism 24 to move from the locked state to the unlocked state. Moving the locking mechanism 24 from the locked state to the unlocked state allows the first gear plate 20 to move relative to the second gear plate 22, which likewise allows the support bracket 16 and seatback 114 to move relative to the mounting bracket 18 and seat bottom 116. Once the desired position of the seatback 114 relative to the seat bottom 116 is achieved, the force applied to the cross rod 46 may be removed, thereby returning the locking mechanism 14 to the locked state and preventing further movement of the first gear plate 20, support bracket 16, and seatback 114 relative to the second gear plate 22, mounting bracket 18, and seat bottom 116.

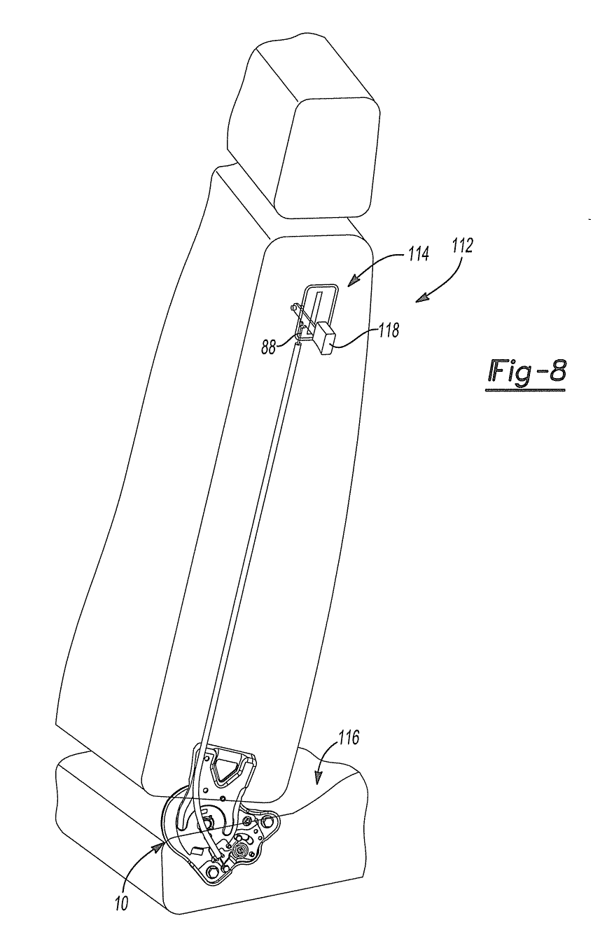

The seatback 114 may be moved into a dumped position (FIG. 8) by applying a force on the release lever 118. Applying a force on the release lever 118 likewise causes a force to be applied to the cable 88, thereby rotating the release lever 68 and moving the dump mechanism 14 from the engaged state to the disengaged state. When the dump mechanism 14 is moved from the engaged state to the disengaged state, the second gear plate 22 is permitted to freely rotate relative to the mounting bracket 18 and, as such, the first gear plate 20, support bracket 16, and seatback 114 are likewise permitted to rotate in the clockwise direction relative the view shown in FIG. 8 relative to the mounting bracket 18 and seat bottom 116.

The seatback 114 may be returned to the upright position (FIGS. 6 and 7) by applying a force on the seatback 114 to rotate the seatback 114 in the counterclockwise direction relative to the view shown in FIG. 8. Once the seatback 114 is sufficiently rotated in the counterclockwise direction relative to the view shown in FIG. 8, the dump mechanism 14 returns to the engaged state, which prevents further rotation of the second gear plate 22 relative to the mounting bracket 18, as described above. When the dump mechanism 14 is returned to the engaged state, the second gear plate 22 and, thus, the first gear plate 20, support bracket 16, and seatback 114 are once again prevented from rotating relative to the mounting bracket 18 and seat bottom 116.

When the seatback 114 is returned to an upright state (FIGS. 6 and 7), the angular position of the seatback 114 relative to the seat bottom 116 is returned to the previous angular position prior to the seatback 114 being moved into the dumped state (FIG. 8). The seatback 114 is returned to the previous angular position relative to the seat bottom 116, as the relative position of the first gear plate 20 and the second gear plate 22 is not changed when the seatback 114 is moved into the dumped state (FIG. 8).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An adjustment mechanism for a seat assembly having a seat bottom and a seatback, the adjustment mechanism comprising:
a mounting bracket fixed for movement with the seat bottom;
a recliner mechanism supported by said mounting bracket and movable between a locked state preventing movement of the seatback relative to the seat bottom and an unlocked state permitting movement of the seatback relative to the seat bottom; and
a dump mechanism supported by said mounting bracket and operable between an engaged state preventing rotation of the seatback relative to the seat bottom when said recliner mechanism is in said locked state and a disengaged state permitting rotation of the seatback relative to the seat bottom when said recliner mechanism is in said locked state.

2. The adjustment mechanism of claim 1, wherein said recliner mechanism is a round-recliner mechanism.

3. The adjustment mechanism of claim 2, wherein said recliner mechanism is a constantly engaged, round-recliner mechanism.

4. The adjustment mechanism of claim 1, wherein said recliner mechanism is a powered recliner mechanism.

5. The adjustment mechanism of claim 1, wherein said dump mechanism includes a locking cam that maintains said dump mechanism in said engaged state.

6. The adjustment mechanism of claim 5, wherein said locking cam is rotatably supported by a pivot relative to said mounting bracket.

7. The adjustment mechanism of claim 6, wherein said locking cam includes an aperture having a larger diameter than an outer diameter of said pivot.

8. The adjustment mechanism of claim 6, wherein said locking cam includes an aperture rotatably receiving said pivot, said aperture having a center of rotation that is offset from a center of rotation of said pivot.

9. The adjustment mechanism of claim 5, wherein said dump mechanism includes an actuator cam disposed between said locking cam and said recliner mechanism, said actuator cam engaging said locking cam and said recliner mechanism when said recliner mechanism is in said locked state and said dump mechanism is in said engaged state.

10. The adjustment mechanism of claim 5, wherein said locking cam translates and rotates relative to said pivot to permit said dump mechanism to move from said engaged state to said disengaged state.

11. An adjustment mechanism for a seat assembly having a seat bottom and a seatback, the adjustment mechanism comprising:
a mounting bracket fixed for movement with the seat bottom;
a recliner mechanism movable between a locked state preventing movement of the seatback relative to the seat bottom and an unlocked state permitting movement of the seatback relative to the seat bottom; and
a dump mechanism operable between an engaged state preventing rotation of the seatback relative to the seat bottom when said recliner mechanism is in said locked state and a disengaged state permitting rotation of the seatback relative to the seat bottom when said recliner mechanism is in said locked state, said dump mechanism including a locking cam supported by said mounting bracket that translates and rotates relative to said mounting bracket to permit movement of said dump mechanism from said engaged state to said disengaged state.

12. The adjustment mechanism of claim 11, wherein said recliner mechanism is a round-recliner mechanism.

13. The adjustment mechanism of claim 12, wherein said recliner mechanism is a constantly engaged, round-recliner mechanism.

14. The adjustment mechanism of claim 11, wherein said recliner mechanism is a powered recliner mechanism.

15. The adjustment mechanism of claim 11, wherein said recliner mechanism and said dump mechanism are supported by said mounting bracket.

16. The adjustment mechanism of claim 11, wherein said locking cam is rotatably supported by a pivot relative to said mounting bracket.

17. The adjustment mechanism of claim 16, wherein said locking cam includes an aperture having a larger diameter than an outer diameter of said pivot to permit said locking cam to selectively translate and rotate relative to said mounting bracket.

18. The adjustment mechanism of claim 16, wherein said locking cam includes an aperture rotatably receiving said pivot, said aperture having a center of rotation that is offset from a center of rotation of said pivot to permit said locking cam to selectively translate and rotate relative to said mounting bracket.

19. The adjustment mechanism of claim 11, wherein said dump mechanism includes an actuator cam disposed between said locking cam and said recliner mechanism, said actuator cam engaging said locking cam and said recliner mechanism when said recliner mechanism is in said locked state and said dump mechanism is in said engaged state.

20. The adjustment mechanism of claim 19, wherein said actuator cam is rotatably supported by an eccentric pivot relative to said housing.
